(19) United States
(12) Patent Application Publication
(10) Pub. No.: US 2026/0212606 A1
(43) Pub. Date: Jul. 23, 2026

(54) METHODS AND SYSTEMS FOR DIGITAL TWINS

(71) Applicant: Dronebase, Inc., Los Angeles, CA (US)

(72) Inventors: Ahmad Jarjis Hasan, Newcastle, WA (US); Jonathan Lwowski, San Antonio, TX (US); Conor Wallace, San Antonio, TX (US)

(21) Appl. No.: 19/268,091

(22) Filed: Jul. 14, 2025

Related U.S. Application Data
(63) Continuation of application No. 19/029,713, filed on Jan. 17, 2025.

(51) Int. Cl. G06T 17/20; G06T 19/20

(52) U.S. Cl. CPC G06T 17/205; G06T 19/20; G06T 2200/24; G06T 2210/56; G06T 2219/2016

(57) ABSTRACT

Methods and systems are described that are configured for generating a digital twin of a physical object. A computing device may process imaging data associated with a physical object captured by one or more imaging devices. The imaging data may be used to generate a point cloud of the physical object. A voxel filter may be applied to the point cloud to reduce one or more data points of the point cloud. A refinement process may be applied to the reduced point cloud to smooth, and increase the accuracy of, the point cloud. The filtered and refined point cloud may then be converted to a digital twin of the physical object. Raycasting and projection may be applied to the imaging data and the digital twin to generate measurement data associated with the physical object allowing a user interact with the digital twin and perform metric analysis.

### CROSS-REFERENCE TO RELATED PATENT APPLICATION

This application is a continuation of U.S. Patent Application No. 19/029,713, filed January 17, 2025, which is incorporated herein by reference in its entirety.

### BACKGROUND

Digital twin technologies are increasingly used for infrastructure monitoring, asset management, and field inspections. For example, digital twins are used to track changes to physical objects, systems, or assets across the object’s lifespan and records the changes as they occur. Digital twins are a complex virtual model that is an exact counterpart to the physical asset existing in real space. Sensors and internet-of-things (IoT) devices connected to the physical asset collect data, often in real-time, that can be mapped to the virtual model of the digital twin. An individual may access the digital twin to view the real-time information about the physical object operating in the real world without having to be physically present and viewing the physical asset while operating the physical object. As such, the digital twin may be used to understand how the physical object may perform in the real world, in addition to how the physical asset may perform in the future using the collected data from the sensors, the IoT devices, and other sources of data and information being collected. Moreover, digital twins can help manufacturers and providers of the physical object with information that helps the manufacturer understand how customers continue to use the products after purchasers have bought the physical object.

However, existing digital twin solutions that often rely on high-fidelity data sources like light detection and ranging (LiDAR) or IoT devices are preliminary optimized for large-scale, high-density applications. These existing solutions generally lack the ability to perform precise 3D-2D correspondences directly from imagery in lightweight, decimated models. In addition, a number of these existing solutions retain dense point clouds or high-resolution meshes, often requiring a substantial amount of storage in order to store these dense point clouds or high-resolution meshes. As such, these existing solutions are unsuitable for on-field or resource-constrained applications. Essentially, these existing solutions lack the flexibility to generate custom point clouds, lack the ability to perform lightweight metric analysis directly from the image data, and depend on dense data representations.

### SUMMARY

It is to be understood that both the following general description and the following detailed description are exemplary and explanatory only and are not restrictive.

Methods, systems, and apparatus for generating a digital twin of a physical object are described. A computing device may process field of view imaging data associated with a physical object being captured by one or more imaging devices. The computing device may use the imaging data to generate a point cloud of the physical object. A voxel filter may be applied to the point cloud in order to reduce one or more data points of the point cloud. A refinement process may be applied to the reduced/decimated point cloud in order to smooth, and increase the accuracy of, the point cloud. The filtered and refined point cloud may then be converted into a mesh representation, or a digital twin, of the physical object. 2D image pixels of the imaging data may be mapped to 3D points of the digital twin and 3D points of the digital twin may be mapped back onto 2D images of the imaging data in order to generate measurement data associated with the physical object for metric analysis. As such, a user may interact with the digital twin and determine the measurement data associated with the physical object.

In an embodiment, disclosed are methods comprising receiving, by a computing device, field of view imaging data associated with an environment from one or more imaging devices, generating, based on the imaging data, a point cloud associated with the environment, generating, based on reducing one or more data points of the point cloud, a decimated point cloud associated with the environment, generating, based on applying a data refinement process to the decimated point cloud, a refined point cloud associated with the environment, and generating, based on the refined point cloud, a mesh representation associated with the environment.

In an embodiment, disclosed are computing devices comprising one or more non-transitory computer-readable media storing processor-executable instructions that, when executed by at least one processor, cause the at least one processor to receive, by a computing device, field of view imaging data associated with an environment from one or more imaging devices, generate, based on the imaging data, a point cloud associated with the environment, generate, based on reducing one or more data points of the point cloud, a decimated point cloud associated with the environment, generate, based on reducing one or more data points of the point cloud, a decimated point cloud associated with the environment, and generate, based on the refined point cloud, a mesh representation associated with the environment.

In an embodiment, disclosed are methods comprising receiving, by a computing device, field of view imaging data associated with an environment from one or more imaging devices, determining, based on a first two images of the imaging data, a scaling process, generating, based on an image of the imaging data, a depth image associated with the environment, generating, based on the determined scaling process and the depth image, a point cloud associated with the environment, generating, based on applying a data refinement process to the point cloud, a refined point cloud associated with the environment, and generating, based on the refined point cloud, a mesh representation associated with the environment.

Additional advantages will be set forth in part in the description which follows or may be learned by practice. The advantages will be realized and attained by means of the elements and combinations particularly pointed out in the appended claims. It is to be understood that both the foregoing general description and the following detailed description are exemplary and explanatory only and are not restrictive.

### BRIEF DESCRIPTION OF THE DRAWINGS

To easily identify the discussion of any particular element or act, the most significant digit or digits in a reference number refer to the figure number in which that element is first introduced.

FIG. 1 shows an example system for generating digital twins;

FIG. 2A shows an example system configuration of an imaging device;

FIG. 2B shows an example system configuration of an imaging device;

FIG. 3A shows an example process for generating digital twins;

FIG. 3B shows an example process for generating digital twins;

FIG. 4 show an example process for generating measurement data;

FIG. 5 shows an example scenario of a generated digital twin;

FIG. 6 shows a flowchart of an example method; and

FIG. 7 shows a flowchart of an example method,

### DETAILED DESCRIPTION

Before the present methods and systems are disclosed and described, it is to be understood that the methods and systems are not limited to specific methods, specific components, or to particular implementations. It is also to be understood that the terminology used herein is for the purpose of describing particular embodiments only and is not intended to be limiting.

As used in the specification and the appended claims, the singular forms “a,” “an” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal embodiment. “Such as” is not used in a restrictive sense, but for explanatory purposes.

Disclosed are components that can be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all aspects of this application including, but not limited to, steps in disclosed methods. Thus, if there are a variety of additional steps that can be performed it is understood that each of these additional steps can be performed with any specific embodiment or combination of embodiments of the disclosed methods.

The present methods and systems may be understood more readily by reference to the following detailed description of preferred embodiments and the examples included therein and to the Figures and their previous and following description.

As will be appreciated by one skilled in the art, the methods and systems may take the form of an entirely hardware embodiment, an entirely software embodiment, or an embodiment combining software and hardware aspects. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, CD-ROMs, optical storage devices, or magnetic storage devices.

Embodiments of the methods and systems are described below with reference to block diagrams and flowchart illustrations of methods, systems, apparatuses and computer program products. It will be understood that each block of the block diagrams and flowchart illustrations, and combinations of blocks in the block diagrams and flowchart illustrations, respectively, can be implemented by computer program instructions. These computer program instructions may be loaded onto a general purpose computer, special purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

Hereinafter, various embodiments of the present disclosure will be described with reference to the accompanying drawings. As used herein, the term “user” may indicate a person who uses an electronic device.

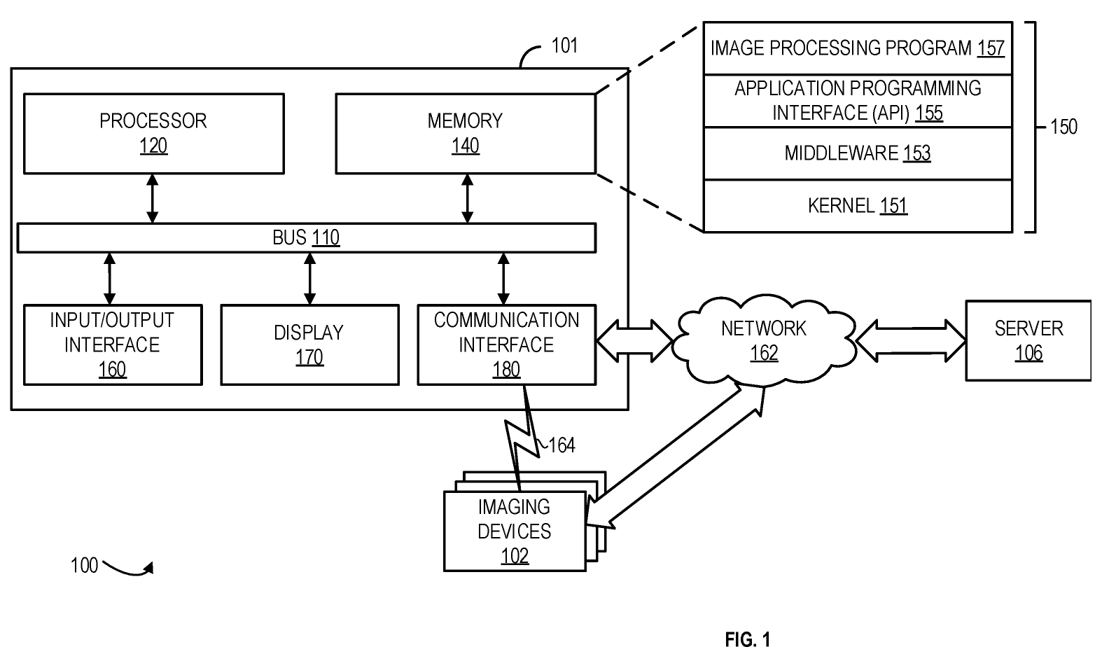

FIG. 1 shows an example system 100 for generating a digital twin of an environment (e.g., a physical object). The system 100 may include a computing device 101 configured to receive imaging data from one or more imaging devices 102 in order to generate a digital twin of the environment. The computing device 101 may comprise a laptop computer, a mobile phone, a smart phone, a tablet computer, a desktop computer, and the like. The computing device 101 may include a bus 110, a processor 120, a memory 140, an input/output interface 160, a display 170, and a communication interface 180. In an example, the computing device 101 may omit at least one of the aforementioned constitutional elements or may additionally include other constitutional elements.

The bus 110 may include a circuit for connecting the processor 120, the memory 140, the input/output interface 160, the display 170, and the communication interface 180 to each other and for delivering communication (e.g., a control message and/or data) between the processor 120, the memory 140, the input/output interface 160, the display 170, and the communication interface 180.

The processor 120 may include one or more of a Central Processing Unit (CPU), an Application Processor (AP), and a Communication Processor (CP). The processor 120 may control, for example, at least one of the memory 140, the input/output interface 160, the display 170, and the communication interface 180 and/or may execute an arithmetic operation or data processing for communication. The processing (or controlling) operation of the processor 120 according to various embodiments is described in detail with reference to the following drawings.

The memory 140 may include a volatile and/or non-volatile memory. The memory 140 may store, for example, a command or data related to at least one different constitutional element of the computing device 101. In an example, the memory 140 may store a software and/or a program 150. The program 150 may include, for example, a kernel 151, a middleware 153, an Application Programming Interface (API) 155, and/or an image processing program (or an “application”) 157, or the like, configured for controlling one or more functions of the computing device 101 and/or an external device (e.g., the imaging devices 102). At least one part of the kernel 151, middleware 153, or API 155 may be referred to as an Operating System (OS). The memory 140 may include a computer-readable recording medium having a program recorded therein to perform the method according to various embodiments by the processor 120.

The kernel 151 may control or manage, for example, system resources (e.g., the bus 110, the processor 120, the memory 130, etc.) used to execute an operation or function implemented in other programs (e.g., the middleware 153, the API 155, or the image processing program 157). Further, the kernel 151 may provide an interface capable of controlling or managing the system resources by accessing individual constitutional elements of the computing device 101 in the middleware 153, the API 155, or the image processing program 157.

The middleware 153 may perform, for example, a mediation role so that the API 145 or the image processing program 157 can communicate with the kernel 151 to exchange data.

Further, the middleware 153 may handle one or more task requests received from the image processing program 157 according to a priority. For example, the middleware 153 may assign a priority of using the system resources (e.g., the bus 110, the processor 120, or the memory 130) of the computing device 101 to at least one of the image processing programs 157. For example, the middleware 153 may process the one or more task requests according to the priority assigned to at least one of the application programs, and thus, may perform scheduling or load balancing on the one or more task requests.

The API 155 may include at least one interface or function (e.g., instruction), for example, for file control, window control, video processing, or character control, as an interface capable of controlling a function provided by the application 157 in the kernel 151 or the middleware 153.

The image processing program 157 may include logic (e.g., hardware, software, firmware, etc.) that may be implemented for generating a digital twin of an environment. The computing device 101 may receive field of view imaging data associated with an environment from one or more imaging devices 102. The environment may comprise one or more physical objects. The one or more imaging devices 102 may comprise one or more RGB camera devices. Each imaging device 102 of the one or more imaging devices 102 may comprise one or more of a gimbal, a GPS sensor, a laser range finder, an accelerometer, or an inertial measurement unit (IMU). As an example, the field of view imaging data may comprise one or more pixel-based digital images of the environment, GPS data associated with the one or more imaging devices, laser range finder (LRF) data, real-time kinematics (RTK) data associated with the one or more imaging devices, distance data associated with the one or more imaging devices, orientation data associated with the one or more imaging device, pose data/metadata, or one or more combinations thereof. For example, the imaging devices 102 may provide pixel-based images associated with metadata (e.g., GPS data, LRF data, RTK data, distance data, orientation data, and the like) to the computing device 101, wherein the computing device 101 may process the pixel-based images associated with the metadata in order to generate the digital twins of the environment.

The image processing program 157 may cause the computing device 101 to generate a point cloud associated with the environment based on the imaging data. For example, the computing device 101 may generate the point cloud from the imaging data using an intrinsic imaging device matrix of each of the imaging devices 102. For example, the LRF data and the imaging devices 102 may be calibrated to identify pixels with ground truth distances in order to increase an efficiency and accuracy of scaling the point cloud. As an example, the orientation data (e.g., IMU data) and the RTK data may be used to refine the GPS data. For example, the orientation data and the RTK data may be combined in order to refine the GPS data. Location data (e.g., coordinates) of each of the imaging devices 102 may be determined based on calculating each imaging device’s 102 Cartesian position from the refined GPS data. In addition, each imaging device’s 102 orientation may be calculated based on the GPS data (e.g., GPS heading) and the RTK data (e.g., RTK yaw). For example, a rotation matrix may be generated based on using gimbal data of the imaging devices 102. Each imaging device’s 102 pose may be calculated, for each image output be each imaging device 102, by combining the Cartesian position of each imaging device 102 and the rotation matrix of each imaging device 102. In an example, the computing device may use the LRF data to scale the point cloud. For example, the computing device 101 may generate the point cloud based on a depth image (e.g., from the imaging data) in an image-based coordinate frame. As an example, an X-axis may point to the right, a Y-axis may point down, and a Z-axis may point forward (e.g., out of the imaging device). The axes may be reordered to “NED-like” and multiplied by an axis relabeling matrix, , wherein the matrix which may convert (x, y, z) (x, y, z) such that the X-axis may point forward, the Y-axis may point to the right, and the Z-axis may point downward. As an example, a gimbal transformation may be applied (e.g., Yaw = 0° from North). Since the gimbal’s yaw ranges from 0-360° relative to true north, the yaw, in addition to roll and pitch, may be incorporated into a 4x4 transformation matrix. In addition, a translation from a GPS offset (e.g., a difference between a current GPS and an origin GPS) in NED coordinates may be determined. A true NED may be determined by multiplying a “NED-like” point cloud by the gimbal transformation + GPS translation in order to align the axes with real-world directions such that the X-axis = geographic north, the Y-axis = east, and the Z-axis = down. Thus, the gimbal yaw may be truly measured from north, and the translation may be based on GPS offsets, resulting in a genuine NED frame in a global sense. The image processing program 157 may cause the computing device 101 to generate a decimated point cloud associated with the environment based on reducing one or more data points of the point cloud. For example, a point density associated with the point cloud may be reduced based on applying voxel filtering to the point cloud. In an example, the image processing program 157 may cause the computing device 101 to map the scaled point cloud into a global reference frame using the Cartesian poses (e.g., global NED). The image processing program 157 may cause the computing device 101 to generate a refined point cloud associated with the environment based on applying a data refinement process to the decimated point cloud. The data refinement process may comprise one or more of a weighted moving least square process or a screened Poisson reconstruction process. In an example, the weighted moving least square process may be initially applied to the decimated point cloud followed by the screened Poisson reconstruction. For example, after applying the weighted moving least square process to the point cloud, a normal of each point of the point cloud may be calculated. The normals of each point may be oriented by applying a minimum spanning tree to the normals of each point. The screened Poissson reconstruction may then be applied to the point cloud to generate a mesh representation associated with the environment. As an example, the image processing program 157 may cause the computing device 101 to generate the mesh representation associated with the environment based on the refined point cloud. The mesh representation associated with the environment may comprise a digital twin of the environment. In an example, the mesh representation may be simplified (e.g., decimated) by reducing a point density associated with the mesh representation. For example, a non-shrinking smoothing function such as a taubin smoothing process may be applied to the mesh representation for a heavier smoothing. In an example, the mesh representation may be trimmed based on a distance from the point cloud, wherein the mesh representation may be decimated based on applying a Quadric Error Metric Decimation to the mesh representation. As such, this may ensure a balance between accuracy and a storage efficiency associated with the mesh representation.

In an example, a time series forecasting process/technique may be used to fill in gaps of the LRF data/values (e.g., a time series comprising LRF data over time). For example, a Seasonal AutoRegressive Integrated Moving Average with eXogenous factors (SARIMAX) model may be used to forecast missing LRF values from the LRF data (e.g., a time series of LRF data) in order to scale an image for generating the mesh representation (e.g., digital twin). In an example, SARIMAX parameters may be determined automatically. This process may ensure continuous sale-accurate distance data is available for subsequent point cloud generation and meshing stages, even when the imaging devices 102 dropout. As an example, initial parameters (p, q, d) may be determined for non-seasonal cases and initial parameters (P, Q, D, m) may be determined for seasonal cases. For example, the initial parameters may affect how the SARIMAX model handles autoregression, differencing, moving average, integration, seasonal component, covariates, covariate component, etc. For each parameter combination, the SARIMAX model fits a candidate model (e.g., training a candidate machine learning model) and evaluates the candidate model using one or more criteria (e.g., a Akaike Information Criterion (AIC) or a Bayesian Information Criterion (BIC)). The combination with the lowest criterion score may be determined. As an example, during fitting, the SARIMAX model runs an internal optimization procedure to adjust one or more coefficients of the SARIMAX model until the predicted values align as closely as possible with the actual (e.g., non-missing) LRF measurements/data. Once the mode is fit, the model may be used to forecast, or to fill in, missing LRF values of the time series LRF data.

In an example, the computing device 101 may be configured to generate digital twins based on images that do not include LRF data. For example, each imaging device 102 may comprise one or more of a gimbal, a GPS sensor, an accelerometer, or an inertial measurement unit. As an example, the field of view imaging data may comprise one or more pixel-based images of the environment, GPS data associated with the one or more imaging devices, real-time kinematics (RTK) data associated with the one or more imaging devices, distance data associated with the one or more imaging devices, orientation data associated with the one or more imaging devices, pose data/metadata, or one or more combinations thereof. The image processing program 157 may cause the computing device 101 to determine a scaling process based on a first two images (e.g., first two frames) of the imaging data. The determined scaling process may comprise triangulating features associated with the first two images according to pose data associated with the one or more imaging devices 102 or optimizing for scale correction to match an expected scene depth according to the pose data. As an example, if the first two images have sufficient features (e.g., a minimum of 8 features around a base of a wind turbine blade), the features of the first two images may be triangulated using the pose data and one or more intrinsic imaging device parameters. The pose data and the one or more intrinsic parameters (e.g., focal length, principal point, skew coefficient, pixels per unit, distortion coefficients, scale, etc.) may be used to scale an initial depth-based point cloud. As an example, if the first two images lack sufficient features, photometric consistency may be assumed between images (e.g., frames) of the imaging data. For example, scale correction may be optimized with known poses (e.g., rotation determined from gimbal data and translation calculated from RTK GPS) in order to match an expected scene depth. As an example, a relative pose may be assumed or estimated between two imaging device 102 viewpoints. An initial depth map may be predicted for one of the images. One image may be warped into another based on using the predicted depth and the known pose (e.g., rotation determined from gimbal data and translation calculated from RTK GPS), for each pixel in the first image, a depth value may be determined to back-project the point into 3D, and then re-projected into a second image’s pixel coordinates. A photometric error may be calculated by comparing the warped image’s pixel intensities to the actual intensities of the pixels of the second image (e.g., sum of absolute differences or squared differences of pixel intensities). The depth may be optimized to minimize photometric error. For example, if pixels are misaligned (e.g., the warped image doesn’t match the real second view), the depths may be adjusted to reduce discrepancy. The image processing program 157 may cause the computing device 101 to generate a depth image associated with the environment based on an image of the imaging data. For example, the computing device 101 may use a depth estimate model (e.g., Depth Anything) to produce a depth image based on the imaging data received from the image device 102. As an example, the initial point cloud may have an arbitrary scale. The image processing program 157 may cause the computing device 101 to generate a point cloud associated with the environment based on the determined scaling process and the depth image. For example, the computing device 101 may convert the depth image to the point cloud using the intrinsic imaging device parameters. Scaling may be applied to the point cloud according to the determined scaling process. For example, an initial point cloud associated with the environment may be generated based on the depth image. For each subsequent image from the imaging data, an existing scaled point cloud may be projected onto the current respective image using the pose data. A new depth image may be generated based on applying scaling from projections in the previous point cloud. The new data may be added to the initial point cloud (e.g. overall point cloud). This process may be repeated with each new image, wherein a progressively scaled point cloud may be generated over time. The image processing program 157 may cause the computing device 101 to generate a refined point cloud associated with the environment based on applying one of the data refinement processes (e.g., weighted moving least square process or screened Poisson reconstruction process) to the point cloud. The image processing program 157 may cause the computing device 101 to generate a mesh representation associated with the environment based on the refined point cloud.

In an example, the computing device 101 may receive, via a user interface of the computing device 101, one or more user interactions with a generated mesh representation. Measurement data associated with the environment (e.g., one more physical objects) may be determined based on the one or more user interactions with the mesh representation. The measurement data may comprise one or more of feature locations associated with the environment, distance measurements associated with the environment, or geospatial coordinates associated with the environment. As an example, the measurement data may be generated based on mapping 2D image pixels of the imaging data to 3D points of the mesh representation (e.g., raycasting) and mapping 3D points of the mesh representation back onto 2D images of the imaging data (e.g., projection).

In an example, the mesh representation may be generated based on an object of interest captured in the environment captured by the imaging devices 102. For example, a large Vision Language Model (VLM), in addition to a Segment Anything 2 Model (SAM2), may be utilized to generate a mesh representation (e.g., digital twin) of the object of interest. For example, a large VLM may be used to encode a user’s text or image data into a compact feature embedding, wherein the compact feature embedding may enable identifying an object in an image based on input received from a user (e.g., input indicating a desired object). In an example, when an image has a plurality of objects, a user may provide an input indicating a desired object to be identified in the image. The SAM2 may be utilized to segment the image, wherein the large VLM may be applied to each segment to determine the segment associated with the desired object. In an example, once a first image is segmented, the next image may be analyzed based on the previous image’s embeddings to determine a segment of the current image with the desired object. For example, an Adapting Segment Anything Model for Zero Shot Visual Tracking with Motion-Aware Memory (SAMURAI) model may be applied to the subsequent images to determine the segment of the current image with the desired object. The mesh representation of the desired object may be generated from the segments with the desired object.

The input/output interface 160 may be configured as an interface for delivering an instruction or data input from a user or a different external device(s) to the processor 120, the memory 140, the input/output interface 160, the display 170, and the communication interface 180. Further, the input/output interface 160 may output an instruction or data received from the processor 120, the memory 140, the input/output interface 160, the display 170, and/or the communication interface 180 to a different external device.

The display 170 may include various types of displays, such as, for example, a Liquid Crystal Display (LCD) display, a Light Emitting Diode (LED) display, an Organic Light-Emitting Diode (OLED) display, a MicroElectroMechanical Systems (MEMS) display, or an electronic paper display. The display 170 may display, for example, a variety of contents (e.g., text, image, video, icon, symbol, etc.) to the user. The display 170 may include a touch screen. For example, the display 170 may receive a touch, gesture, proximity, or hovering input by using a stylus pen or a part of a user's body. In an example, the display 170 may comprise a visual interface for interacting with a digital twin. For example, the visual interface may be configured to output a digital twin of an environment (e.g., one or more physical objects) based on imaging data of the environment received from the imaging devices 102. Based on one or more user interactions, the user interface may be configured to output the measurement data.

The communication interface 170 may establish, for example, communication between the computing device 101 and an external device (e.g., the imaging devices 102 and/or the server 106). For example, the communication interface 170 may communicate with the external device (e.g., the imaging devices 102 and/or the server 106) by being connected to a network 162 via wireless communication or wired communication. For example, as a cellular communication protocol, the wireless communication may use at least one of Long-Term Evolution (LTE), LTE Advance (LTE-A), Code Division Multiple Access (CDMA), Wideband CDMA (WCDMA), Universal Mobile Telecommunications System (UMTS), Wireless Broadband (WiBro), Global System for Mobile Communications (GSM), and the like. In an example, the network 162 may include, for example, at least one of a telecommunications network, a computer network (e.g., LAN or WAN), the internet, and a telephone network.

In addition, the communication interface 170 may communicate with the external device (e.g., the imaging devices 102 and/or the server 106 via communication path 164) via wireless communication or wired communication. The wireless communication 164 may include, for example, a near-distance communication. The near-distance communications 164 may include, for example, at least one of Wireless Fidelity (WiFi), Bluetooth, Near Field Communication (NFC), Global Navigation Satellite System (GNSS), and the like. According to a usage region or a bandwidth or the like, the GNSS may include, for example, at least one of Global Positioning System (GPS), Global Navigation Satellite System (Glonass), Beidou Navigation Satellite System (hereinafter, “Beidou”), Galileo, the European global satellite-based navigation system, and the like. Hereinafter, the “GPS” and the “GNSS” may be used interchangeably in the present document. The wired communication 164 may include, for example, at least one of Universal Serial Bus (USB), High Definition Multimedia Interface (HDMI), Recommended Standard-232 (RS-232), power-line communication, Plain Old Telephone Service (POTS), and the like.

The server 106 may comprise a group of one or more servers. In an example, all or some of the operations executed by the computing device 101 may be executed in a different one or a plurality of electronic devices (e.g., the imaging devices 102 and/or the server 106). In an example, if the computing device 101 needs to perform a certain function or service either automatically or based on a request, the computing device 101 may request at least some parts of functions related thereto alternatively or additionally to a different electronic device (e.g., the imaging devices 102 and/or the server 106) instead of executing the function or the service autonomously. The different electronic devices (e.g., the imaging devices 102 and/or the server 106) may execute the requested function or additional function, and may deliver a result thereof to the computing device 101. The computing device 101 may provide the requested function or service either directly or by additionally processing the received result. For example, a cloud computing, distributed computing, or client-server computing technique may be used.

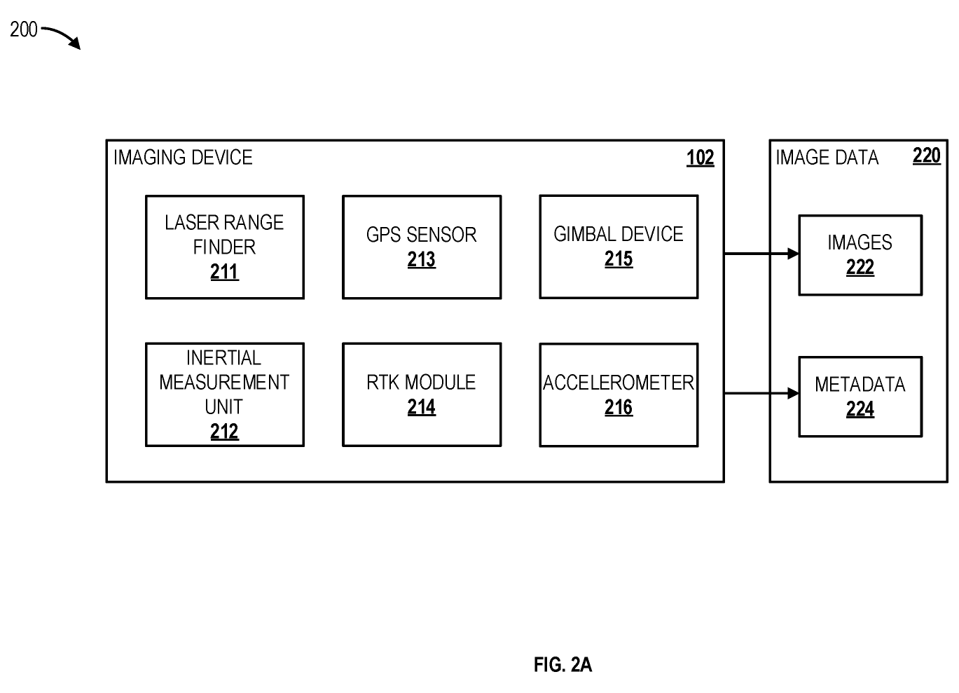

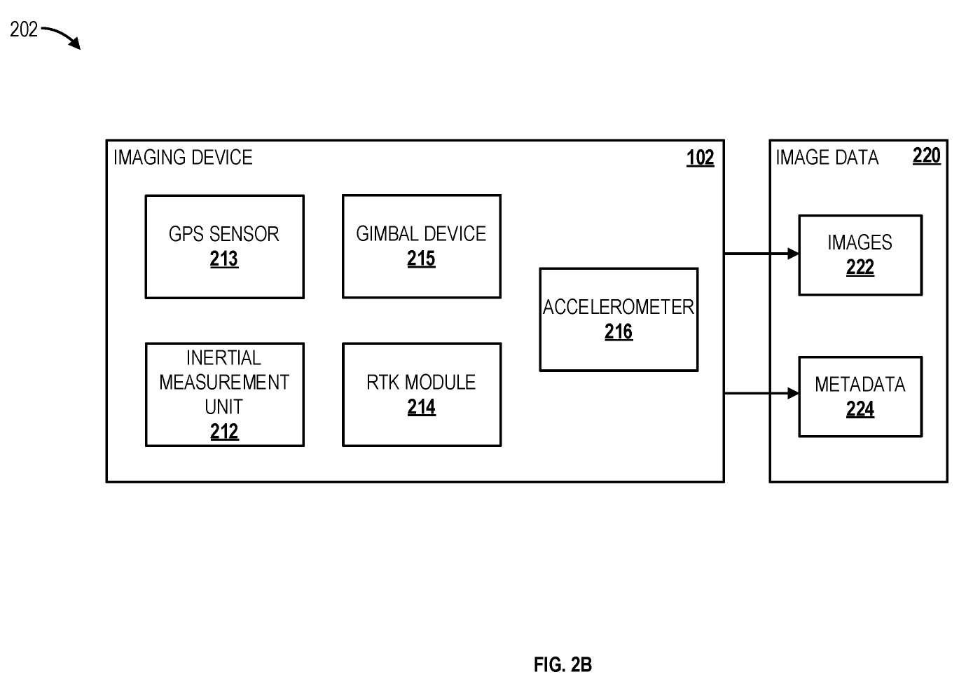

FIGS. 2A-2B show example system configurations 200, 202 of an imaging device (e.g., imaging devices 102). As an example, as shown in FIG. 2A, an imaging device 102 may comprise one or more of a laser range finder (LRF) 211, an inertial measurement unit (IMU) 212, a GPS sensor/device 213, a real-time kinematic (RTK) module 214, a gimbal device 215, and/or an accelerometer 216. The imaging device 102 may be configured to output imaging data 220 of an environment containing one or more physical objects. The imaging data 220 may comprise one or more pixel-based digital images 222 of the environment and metadata 224 associated with the digital images 222. The metadata 224 may comprise data output by one or more of the laser range finder (LRF) 211, the inertial measurement unit (IMU) 212, the GPS sensor/device 213, the real-time kinematic (RTK) module 214, the gimbal device 215, and/or the accelerometer 216. For example, the metadata 224 may comprise GPS data associated with the imaging device 102, laser range finder (LRF) data, real-time kinematics (RTK) data associated with the imaging device 102, distance data associated with the imaging device 102, orientation data associated with the imaging device 102, pose metadata, or one or more combinations thereof. The imaging device 102 may output the imaging data 220 of the environment to a computing device (e.g., computing device 101). The computing device may process the digital images 222 and the metadata 224 in order to generate a digital twin of the environment (e.g., the one or more physical objects). As an example, the digital images 222 may be combined with the LRF 211 data along with other metadata 224 (e.g., IMU 212 data, GPS 213 data, RTK 214 data, gimbal orientation 215 data, accelerometer 216 data, etc.) in order to generate the digital twin. The LRF 211 data may enable absolute scaling that enhances depth estimation. The IMU 212 data may be used for frequent updates of the imaging device’s 102 orientation and the RTK 214 data may be used to increase an accuracy of the imaging device’s 102 position/location. As an example, the IMU 212 data and the RTK 214 may be combined (e.g., via sensor fusion) in order to refine the GPS 213 positioning data. The imaging device’s 102 Cartesian position may be calculated from the refined GPS 213 positioning data after setting a first GPS location of the imaging device 102 as an initial position. The imaging device’s 102 orientation may be determined based on applying a complementary filter to fuse GPS 213 heading data and RTK 214 yaw data, increasing an accuracy of a yaw measurement of the imaging device 102 (e.g., a combination of a low-pass and high-pass filter to estimate orientation by combining accelerometer data and gyroscope data). The gimbal orientation 215 data may be used to determine roll and pitch of the imaging device 102 which may be combined to generate a rotation matrix associated with the imaging device 102 (e.g., using Euler angles). The imaging device’s 102 Cartesian pose may be determined for each image by combining the Cartesian position and the rotation matrix.

The computing device may use the Cartesian pose in generating a point cloud associated with the environment. For example, the computing device may generate the point cloud based on the digital images 222 using intrinsic imaging device matrix data. The computing device may then scale the point cloud using the LRF 211 data. For example, the LRF 211 data and the imaging device 102 may be calibrated in order to identify pixels with ground truth distances and accurately scale the point cloud. For example, the LRF 211 may be calibrated with the imaging device 102. For example, an extrinsic RIT (e.g., Rotation, Translation) between an imaging sensor of the imaging device 102 and the LRF 211 may be determined in order to determine which pixel the LRF 211 is reporting a range from, thus, allowing a current relative point cloud to be scaled. For example, by knowing which pixel of the imaging sensor of the imaging device 102 is reporting range information, the pixel reported by the LRF 211 of the depth image generated by the imaging device 102 may be analyzed. For example, if the depth image indicates a 10unit but the pixel reported by the LRF 211 indicates a 20unit, relative depths in the depth image may need to be multiplied by a scale of 2. Voxel filtering may be applied to the point cloud to reduce a point density of the point cloud, resulting in a decimated point cloud. The scaled point cloud may be mapped into a global reference frame using the calculated Cartesian poses of the imaging device 102.

As an example, the computing device may generate the point cloud based on a depth image (e.g., from the imaging data) in an image-based coordinate frame. As an example, an X-axis may point to the right, a Y-axis may point down, and a Z-axis may point forward (e.g., out of the imaging device). The axes may be reordered to “NED-like” and multiplied by a simple axis relabeling matrix: which may convert (x, y, z) (x, y, z) such that the X-axis may point forward, the Y-axis may point to the right, and the Z-axis may point downward. As an example, a gimbal transformation may be applied (e.g., Yaw = 0° from North). Since the gimbal’s yaw ranges from 0-360° relative to true north, the yaw, in addition to roll and pitch, may be incorporated into a 4x4 transformation matrix. In addition, a translation from a GPS offset (e.g., a difference between a current GPS and an origin GPS) in NED coordinates may be determined. A true NED may be determined by multiplying an “NED-like” point cloud by the gimbal transformation + GPS translation in order to align the axes with real-world directions such that the X-axis = geographic north, the Y-axis = east, and the Z-axis = down. Thus, the gimbal yaw may be truly measured from north, and the translation is based on GPS offsets, resulting in a genuine NED frame in a global sense.

A refinement process (e.g., a weighted moving least squares (WMLS) process/method and/or a screened Poisson reconstruction process/method) may be used to refine (e.g., smoothen) the point cloud. For example, the weighted moving least square process may be initially applied to the point cloud followed by the screened Poisson reconstruction. For example, after applying the weighted moving least square process to the point cloud, a normal of each point of the point cloud may be calculated. The normals of each point may be oriented by applying a minimum spanning tree to the normals of each point. The screened Poissson reconstruction may then be applied to the point cloud to generate a mesh representation associated with the environment. The filtered and refined point cloud may then be converted into a mesh representation, or a digital twin, of the environment (e.g., physical object), capturing essential structural details of the environment. For example, the imaging device 102 may capture images of a wind turbine and generate a digital twin of the wind turbine based on the captured images that may be used to determine measurement data of the wind turbine according to a real-world simulation. For example, a user may interact with the digital twin to determine measurement data of the wind turbine, such as lengths of one or more blades of the wind turbine or simulate the behavior of the wind turbine. For example, a user may interact with the digital twin to determine 3D coordinates and GPS locations of different 3D points of the wind turbine. In an example, defects of the wind turbine may be determined/identified based on interacting with the digital twin, wherein it may be determined if the defect is worsening overtime (e.g., predictive analysis). In an example, a point density of the mesh representation may be further reduced, ensuring a balance between an accuracy and an storage efficiency of the digital twin. For example, a user may provide input setting a 1% fault/error threshold according to an object’s bounding box (e.g., X meters diagonally) or by absolute number in metric unit ( e.g., X mm). A mesh representation subsequently generated from the point cloud may be iteratively decimated until the Hausdorff distance between an original and a decimated mesh representation is within the fault threshold. For example, a non-shrinking smoothing function such as a taubin smoothing process may be applied to the mesh representation for a heavier smoothing. In an example, the mesh representation may be trimmed based on a distance from the point cloud, wherein the mesh representation may be decimated based on applying a Quadric Error Metric Decimation to the mesh representation.

In an example, as shown in FIG. 2B, the imaging device 102 may not include a LRF 211. Instead, the imaging device 102 may comprise one or more of an inertial measurement unit (IMU) 212, a GPS sensor/device 213, a real-time kinematic (RTK) module 214, a gimbal device 215, and/or an accelerometer 216. As an example, the metadata may comprise one or more pixel-based images of the environment, GPS data associated with the one or more imaging devices, real-time kinematics (RTK) data associated with the one or more imaging devices, distance data associated with the one or more imaging devices, orientation data associated with the one or more imaging devices, pose data, or one or more combinations thereof. The imaging device 102 may be configured to generate digital twins based on imaging data 220 that does not include LRF 211 data. For example, if a first two frames/images of the digital images 222 have sufficient features (e.g., a minimum of 8 features around a base of a wind turbine blade), the features of the first two frames may be triangulated using the pose data and one or more intrinsic imaging device parameters. The pose data and one or more intrinsic imaging device parameters (e.g., focal length, principal point, skew coefficient, pixels per unit, distortion coefficients, scale, etc.) may be used to scale an initial depth-based point cloud. As an example, if the first two frames/images lack sufficient features, photometric consistency may be assumed between frames of the digital images 222. For example, scale correction may be optimized with known poses (e.g., rotation determined from gimbal data and translation calculated from RTK GPS) in order to match an expected scene depth. As an example, a relative pose may be assumed or estimated between two imaging device 102 viewpoints. An initial depth map may be predicted for one of the images. One image may be warped into another based on using the predicted depth and the known pose (e.g., rotation determined from gimbal data and translation calculated from RTK GPS), for each pixel in the first image, a depth value may be determined to back-project the point into 3D, and then re-projected into a second image’s pixel coordinates. A photometric error may be calculated by comparing the warped image’s pixel intensities to the actual intensities of the pixels of the second image (e.g., sum of absolute differences or squared differences of pixel intensities). The depth may be optimized to minimize photometric error. For example, if pixels are misaligned (e.g., the warped image doesn’t match the real second view), the depths may be adjusted to reduce discrepancy. A depth image associated with the environment may be generated based on one of the digital images 222. For example, a depth estimate model (e.g., Depth Anything) may be used to produce a depth image based on the digital images 222. As an example, the initial point cloud may have an arbitrary scale. A point cloud associated with the environment may be generated based on the determined scaling process and the depth image. The depth image may be converted to the point cloud using the intrinsic imaging device parameters. Scaling may be applied to the point cloud according to the determined scaling process. For example, an initial point cloud associated with the environment may be generated based on the depth image. For each subsequent digital image of the digital images 222, an existing scaled point cloud may be projected onto the current respective image using the pose data. A new depth image may be generated based on applying scaling from projections in the previous point cloud. The new data may be added to the initial point cloud (e.g. overall point cloud). This process may be repeated with each new image, wherein a progressively scaled point cloud may be generated over time. A time series forecasting process with SARIMAX may be applied to the scaled point cloud, wherein the result may be converted into a mesh representation, or a digital twin, of the environment (e.g., physical object), capturing essential structural details of the environment. In an example, image overlap may be determined in order to scale a propagation. For example, a previous point cloud that is scaled may be projected to a subsequent image, wherein corresponding depth values may be compared and the scaled point cloud may be updated based on the projected points. The result may be converted into a mesh representation, or a digital twin, of the environment. A point density of the mesh representation may be further reduced, ensuring a balance between an accuracy and a storage efficiency of the digital twin. For example, a user may provide input setting a 1% fault/error threshold according to an object’s bounding box (e.g., X meters diagonally) or by absolute number in metric unit ( e.g., X mm). A mesh representation subsequently generated from the point cloud may be iteratively decimated until the Hausdorff distance between an original and a decimated mesh representation is within the fault threshold. For example, a non-shrinking smoothing function such as a taubin smoothing process may be applied to the mesh representation for a heavier smoothing. In an example, the mesh representation may be trimmed based on a distance from the point cloud, wherein the mesh representation may be decimated based on applying a Quadric Error Metric Decimation to the mesh representation.

By way of example, the imaging devices 102 may include any combination of the laser range finder (LRF) 211, the inertial measurement unit (IMU) 212, the GPS sensor/device 213, the real-time kinematic (RTK) module 214, the gimbal device 215, and/or the accelerometer 216 and is not limited to any single combination.

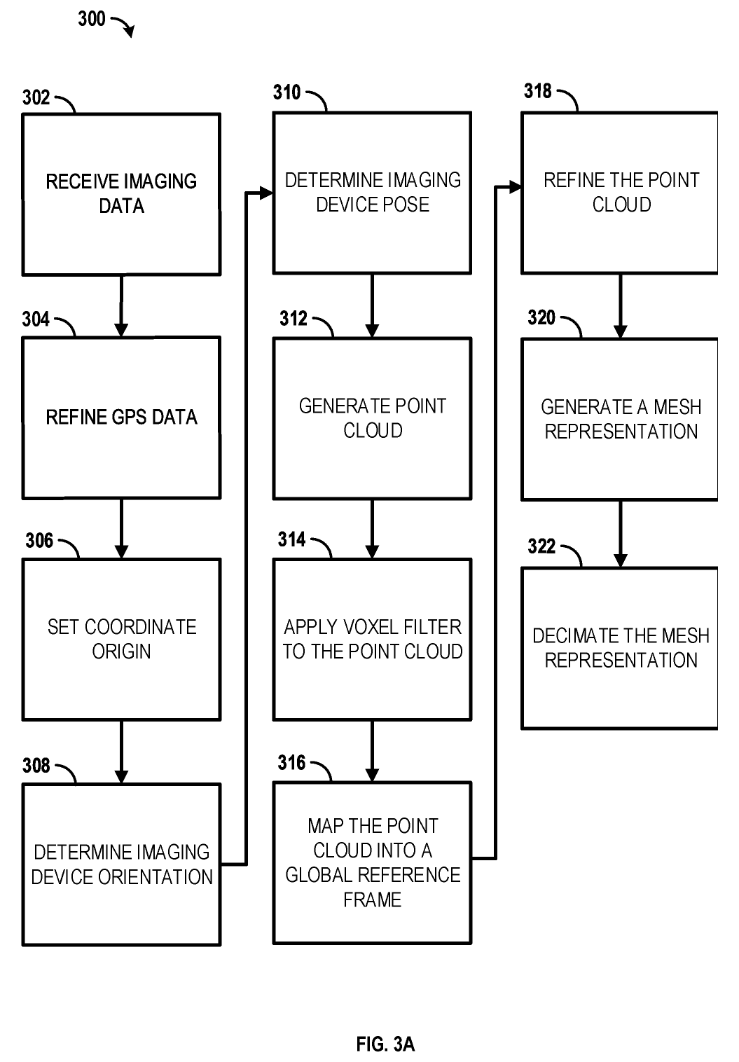

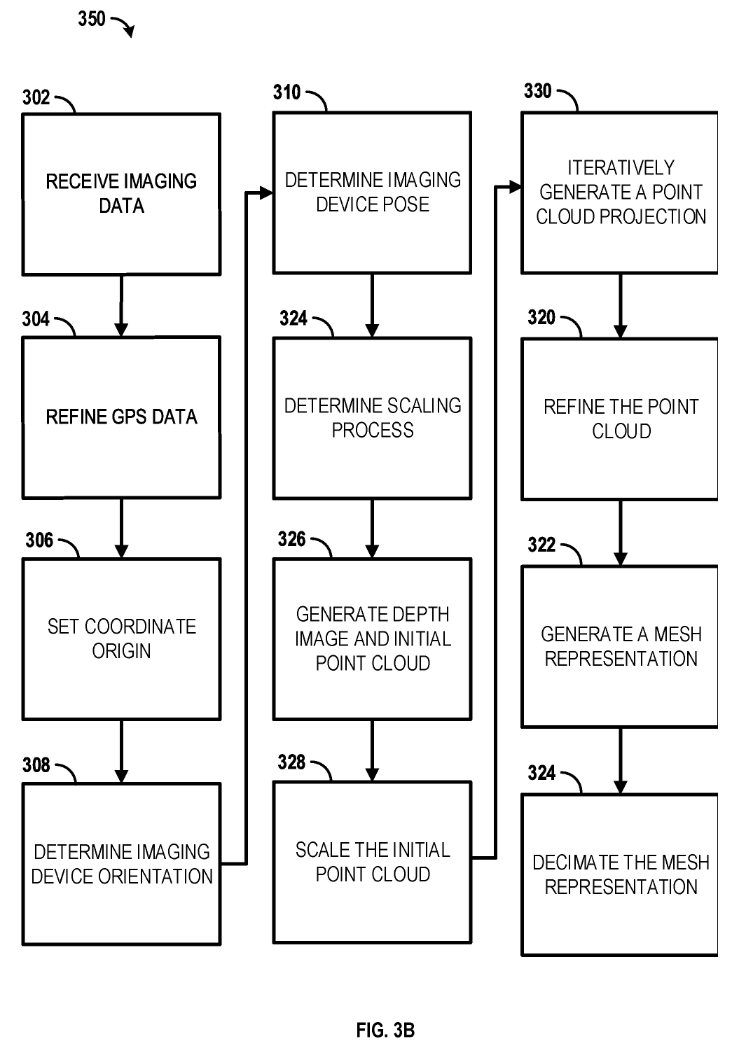

FIGS. 3A shows a flow chart of an example process 300 for generating digital twins when the imaging data includes laser range finder (LRF) data. The process 300 may be implemented by a computing device such as computing device 101, imaging devices 102, combinations thereof, and the like. At step 302, imaging data associated with an environment may be received. The environment may comprise one or more physical objects. The imaging data may comprise one or more pixel-based digital images of the environment, GPS data associated with the one or more imaging devices, LRF data, real-time kinematics (RTK) data associated with the one or more imaging devices, distance data associated with the one or more imaging devices, orientation data associated with the one or more imaging device, pose data/metadata, or one or more combinations thereof. For example, the imaging data may be received by a computing device (e.g., computing device 101) from one or more imaging devices (e.g., imaging devices 102), wherein each imaging device of the one or more imaging devices may comprise one or more of a gimbal, a GPS sensor, a laser range finder, an accelerometer, or an inertial measurement unit (IMU).

At step 304, GPS positioning data may be refined based on combining (e.g., via sensor fusion) IMU data and the RTK data.

At step 306, a coordinate origin may be set based on defining a first GPS location of the one or more imaging devices as an origin and then calculating a Cartesian position of each of the imaging devices based on the refined GPS positioning data.

At step 308, an orientation of each of the imaging devices may be determined based on applying a complementary filter to combine GPS heading data and RTK yaw data (e.g., a combination of a low-pass and high-pass filter to estimate an orientation/yaw of each of the imaging devices by combining accelerometer data and gyroscope data). In an example, roll and pitch of each of the imaging devices may be determined in order to generate a rotation matrix (e.g., using the Euler angles).

At step 310, a pose for each image of each of the imaging devices may be determined based on the Cartesian positions of each of the imaging devices and the rotation matrix of each of the imaging devices.

At step 312, a point cloud may be generated based on the imaging data. As an example, the point cloud may be generated based on the one or more pixel-based digital images of the environment using an intrinsic imaging device matrix of each of the imaging devices. In addition, the point cloud may be scaled based on the LRF data. For example, the LRF data and each of the imaging devices may be calibrated in order to identify pixels with ground truth distances and to scale the point cloud.

At step 314, voxel filtering may be applied to the scaled point cloud in order to reduce a point density of the point cloud, resulting in a decimated point cloud.

At step 316, the calculated Cartesian poses may be used to map the scaled point cloud into a global reference frame. For example, the point cloud may be generated based on a depth image (e.g., from the imaging data) in an image-based coordinate frame. As an example, an X-axis may point to the right, a Y-axis may point down, and a Z-axis may point forward (e.g., out of the imaging device). The axes may be reordered to “NED-like” and multiplied by a simple axis relabeling matrix: which may convert (x, y, z) (x, y, z) such that the X-axis may point forward, the Y-axis may point to the right, and the Z-axis may point downward. As an example, a gimbal transformation may be applied (e.g., Yaw = 0° from North). Since the gimbal’s yaw ranges from 0-360° relative to true north, the yaw, in addition to roll and pitch, may be incorporated into a 4x4 transformation matrix. In addition, a translation from a GPS offset (e.g., a difference between a current GPS and an origin GPS) in NED coordinates may be determined. A true NED may be determined by multiplying an “NED-like” point cloud by the gimbal transformation + GPS translation in order to align the axes with real-world directions such that the X-axis = geographic north, the Y-axis = east, and the Z-axis = down. Thus, the gimbal yaw may be truly measured from north, and the translation is based on GPS offsets, resulting in a genuine NED frame in a global sense.

At step 318, a refinement process (e.g., a weighted moving least squares (WMLS) process/method and/or a screened Poisson reconstruction process/method) may be used to refine (e.g., smoothen) the point cloud in order to smooth and increase an accuracy of the point cloud. As an example, a WMLS may be used to improve point cloud accuracy by correcting depth estimates. A radius-based area around each point in the cloud may be defined. Ground truth data from the LRF data may be used to implement absolute scaling. As an example, the weighted moving least square process may be initially applied to the decimated point cloud followed by the screened Poisson reconstruction. For example, after applying the weighted moving least square process to the point cloud, a normal of each point of the point cloud may be calculated. The normals of each point may be oriented by applying a minimum spanning tree to the normals of each point. The screened Poissson reconstruction may then be applied to the point cloud to generate a mesh representation associated with the environment. A Gaussian fall-off may be applied in order to adjust weights, giving more truth to points closer to the true distance. For example, Gaussian weights may ensure points near a ground truth (e.g., depth from laser range finder) are weighted higher, wherein the weight decreases the further the points are from the ground truth. Weighted points from overlapping images may be averaged, moving the MLS surface closer to ground truth values, and thus, increasing point cloud accuracy.

At step 320, a mesh representation, or digital twin, may be generated based on the filtered and refined point cloud. For example, the filtered and refined point cloud may be converted into a mesh representation of the environment, capturing essential structural details of the environment.

At step 322, the mesh representation may be further decimated. For example, a point density of the mesh representation may be reduced in order to ensure a balance between an accuracy and a storage efficiency of the mesh representation. For example, a user may provide input setting a 1% fault/error threshold according to an object’s bounding box (e.g., X meters diagonally) or by absolute number in metric unit ( e.g., X mm). A mesh representation subsequently generated from the point cloud may be iteratively decimated until the Hausdorff distance between an original and a decimated mesh representation is within the fault threshold. For example, a non-shrinking smoothing function such as a taubin smoothing process may be applied to the mesh representation for a heavier smoothing. In an example, the mesh representation may be trimmed based on a distance from the point cloud, wherein the mesh representation may be decimated based on applying a Quadric Error Metric Decimation to the mesh representation.

FIG. 3B shows a flow chart of an example process 350 for generating digital twins when the imaging data does not include laser range finder (LRF) data. The process 350 may be implemented by a computing device such as computing device 101, imaging devices 102, combinations thereof, and the like. As an example, the imaging data received at step 302 may comprise one or more pixel-based images of the environment, GPS data associated with the one or more imaging devices, real-time kinematics (RTK) data associated with the one or more imaging devices, distance data associated with the one or more imaging devices, orientation data associated with the one or more imaging devices, pose metadata, or one or more combinations thereof. As an example, steps 312, 314, and 316 of the process 300 show in FIG. 3A may be replaced with steps 324, 326, 328, and 330, as shown in FIG. 3B. At step 324, a scaling process may be determined based on a first two images (e.g., first two frames) of the imaging data. The determined scaling process may comprise triangulating features associated with the first two images according to pose data associated with the one or more imaging devices or optimizing for scale correction to match an expected scene depth according to the pose data. As an example, if the first two images have sufficient features (e.g., around a base of a wind turbine blade), the features of the first two images may be triangulated using the pose data and one or more intrinsic imaging device parameters. The pose data and the one or more intrinsic imaging device parameters (e.g., focal length, principal point, skew coefficient, pixels per unit, distortion coefficients, scale, etc.) may be used to scale an initial depth-based point cloud. As an example, if the first two images lack sufficient features, photometric consistency may be assumed between images. For example, scale correction may be optimized with known poses (e.g., rotation determined from gimbal data and translation calculated from RTK GPS) in order to match an expected scene depth. At step 326, a depth image may be generated from the imaging data based on applying a depth estimation model (e.g., Depth Anything) to an image of the imaging data and an initial point cloud may be generated based on converting the depth image to the initial point cloud using the intrinsic imaging device parameters. At step 328, scaling may be applied to the point cloud according to the determined scaling process. At step 330, a point cloud projection may be iteratively generated. For example, for each subsequent image of the imaging data, an existing scaled point cloud may be projected onto the current respective image using the pose data. A new depth image may be generated based on applying scaling from projections in the previous point cloud. The new data may be added to the initial point cloud (e.g. overall point cloud). This process may be repeated with each new image, wherein a progressively scaled point cloud may be generated over time.

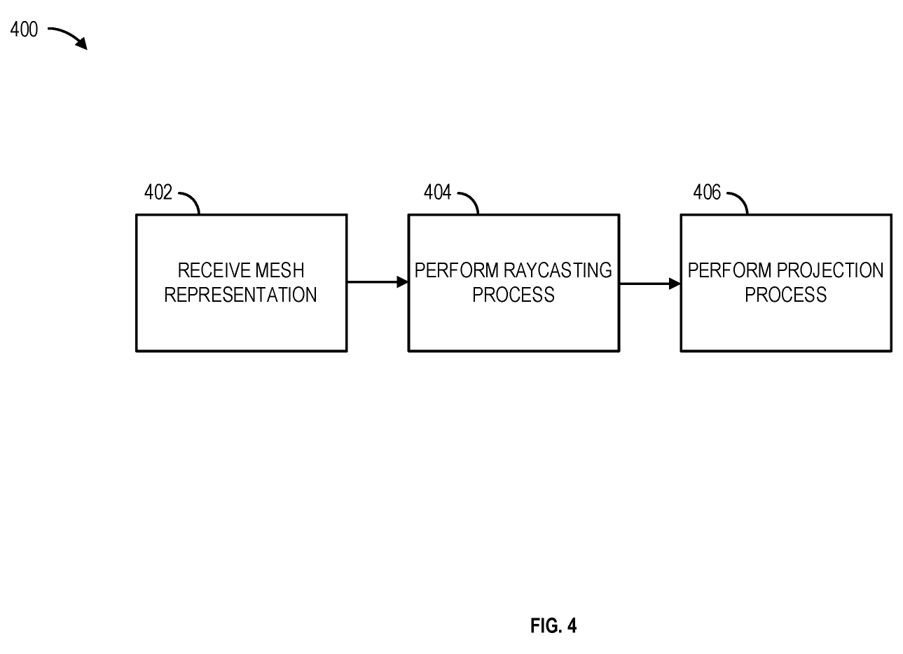

FIG. 4 shows flow chart of an example process 400 for generating measurement data associated with a digital twin. The process 400 may be implemented by a computing device such as computing device 101, imaging devices 102, combinations thereof, and the like. At step 402, a mesh representation, or a digital twin, of an environment (e.g., one or more physical objects) may be received. At step 404, a raycasting process may be implemented in order to enable users to select a 2D image pixel and trace the pixel to a corresponding 3D location within the mesh representation in order to facilitate spatial queries (e.g., enabling interactions with the mesh representation). For example, 2D image pixels of the imaging data may be mapped to 3D points of the mesh representation. At step 406, a projection process may be performed in order to project 3D points of the mesh representation onto 2D images of the image data to generate a direct correspondence that allows for image-based metric analysis (e.g., determine measurement data associated with the environment and/or the one or more physical objects based on interacting with the mesh representation). For example, the 3D points of the mesh representation may be mapped back onto the 2D images of the imaging data. For example, by implementing the raycasting and projection processes, a user may interact with the digital twin to determine measurement data of the wind turbine, such as lengths of one or more blades of the wind turbine or simulate the behavior of the wind turbine. For example, a user may interact with the digital twin to determine 3D coordinates and GPS locations of different 3D points of the wind turbine. In an example, defects of the wind turbine may be determined/identified based on interacting with the digital twin, wherein it may be determined if the defect is worsening overtime (e.g., predictive analysis).

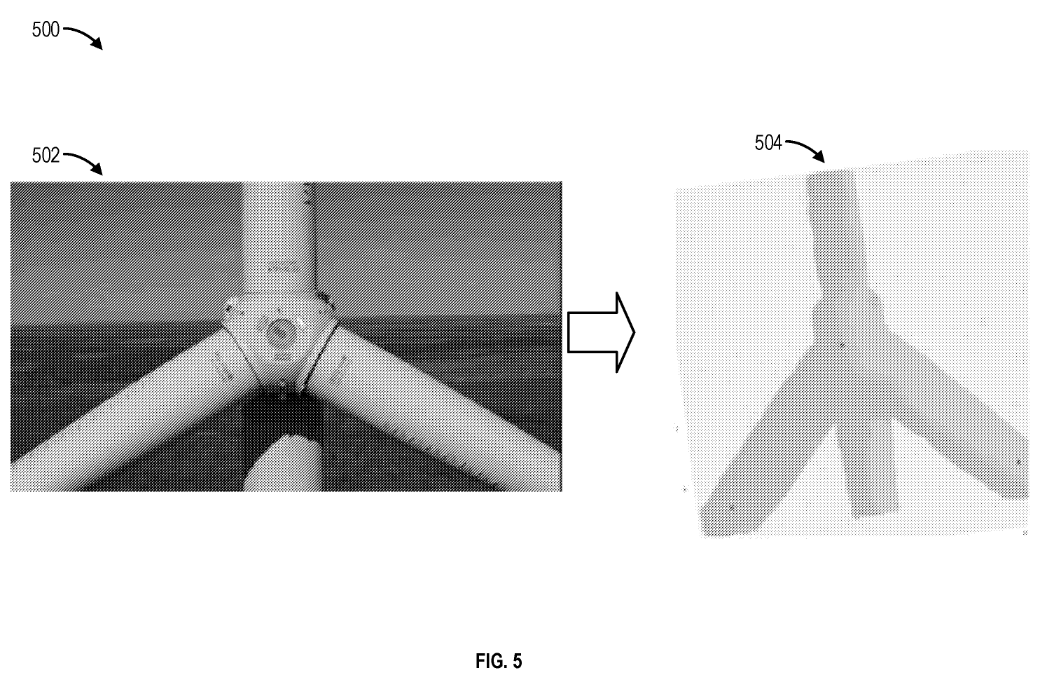

FIG. 5 shows an example scenario 500 of a digital twin generated based on imaging data of a physical object. As shown in FIG. 5, imaging data 502 of a physical object may be processed in order to generate a mesh representation 504 (e.g., digital twin) of the physical object. As an example, one or more user interactions with the mesh representation (e.g., user manipulations of the mesh representation) may be received via a user interface of a computing device (e.g., computing device 101). For example, a user may interact with the mesh representation 504 to determine measurement data of the wind turbine, such as lengths of one or more blades of the wind turbine or simulate the behavior of the wind turbine. For example, a user may interact with the mesh representation 504 to determine 3D coordinates and GPS locations of different 3D points of the wind turbine. In an example, defects of the wind turbine may be determined/identified based on interacting with the mesh representation 504, wherein it may be determined if the defect is worsening overtime (e.g., predictive analysis). Measurement data may be determined based on the one or more user interactions with the mesh representation. The measurement data may comprise one or more of feature locations associated with the physical object, distance measurements associated with the physical object, or geospatial coordinates associated with the physical object. As an example, the measurement data may be generated based on mapping2D image pixels of the imaging data to 3D points of the mesh representation and mapping 3D points of the mesh representation back onto 2D images of the imaging data. For example, a user may interact with edge points of a digital twin of a wind turbine in order to determine distances/measurements between the edge point and a center point, such as from an edge of a blade of the wind turbine to a center point of the blade. As an example, by producing a digital twin based on a decimated point cloud and a decimated mesh, a size of the digital twin may be reduced freeing up storage space for storing the digital twin.

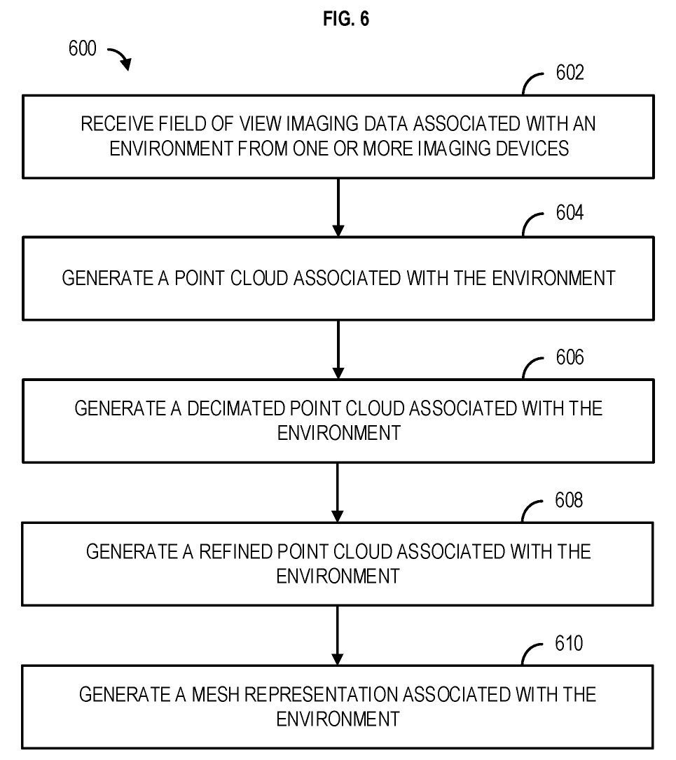

FIG. 6 shows a flowchart of an example method 600 for generating digital twins when the imaging data includes laser range finder (LRF) data. The method 600 may be implemented by a computing device such as computing device 101, imaging devices 102, combinations thereof, and the like. At step 602, field of view imaging data associated with an environment may be received from one or more imaging devices. For example, a computing device (e.g., computing device 101) may receive the field of view imaging data associated with an environment from the one or more imaging devices (e.g., imaging devices 102). The one or more imaging devices may comprise one or more RGB camera devices. Each imaging device of the one or more imaging devices may comprise one or more of a gimbal, a GPS sensor, a laser range finder, an accelerometer, or an inertial measurement unit (IMU). The field of view imaging data may comprise one or more pixel-based digital images of the environment, GPS data associated with the one or more imaging devices, LRF data, real-time kinematics (RTK) data associated with the one or more imaging devices, distance data associated with the one or more imaging devices, orientation data associated with the one or more imaging device, pose metadata, or one or more combinations thereof. The environment may comprise one or more physical objects.

At step 604, a point cloud associated with the environment may be generated based on the imaging data. For example, the computing device (e.g., computing device 101) may generate the point cloud associated with the environment based on the imaging data. As an example, GPS positioning data may be refined based on combining (e.g., via sensor fusion) IMU data and the RTK data of the one or more image imaging devices. A coordinate origin may be set based on defining a first GPS location of the one or more imaging devices as an origin and then calculating a Cartesian position of each of the imaging devices based on the refined GPS positioning data. An orientation of each of the imaging devices may be determined based on applying a complementary filter to combine GPS heading data and RTK yaw data (e.g., a combination of a low-pass and high-pass filter to estimate an orientation/yaw of each of the imaging devices by combining accelerometer data and gyroscope data). In an example, roll and pitch of each of the imaging devices may be determined in order to generate a rotation matrix (e.g., using the Euler angles). A pose for each image of each of the imaging devices may be determined based on the Cartesian positions of each of the imaging devices and the rotation matrix of each of the imaging devices. The point cloud may be generated based on the one or more pixel-based digital images of the environment using an intrinsic imaging device matrix of each of the imaging devices. In addition, the point cloud may be scaled based on the LRF data. For example, the LRF data and each of the imaging devices may be calibrated in order to identify pixels with ground truth distances and to scale the point cloud.

At step 606, a decimated point cloud associated with the environment may be generated based on reducing one or more data points of the point cloud. For example, the computing device (e.g., computing device 101) may generate the decimated point cloud associated with the environment based on reducing the one or more data points of the point cloud. As an example, reducing the one or more data points of the point cloud may comprise reducing, based on applying voxel filtering to the point cloud, a point density associated with the point cloud.

At step 608, a refined point cloud associated with the environment may be generated based on applying a data refinement process to the decimated point cloud. For example, the computing device (e.g., computing device 101) may generate the refined point cloud associated with the environment based on applying the data refinement process to the decimated point cloud. The refinement process may comprise a weighted moving least square (WMLS) process or a screened Poisson reconstruction process. As an example, a WMLS may be used to improve point cloud accuracy by correcting depth estimates. A radius-based area around each point in the cloud may be defined. Ground truth data from the LRF may be used to implement absolute scaling. A Gaussian fall-off may be applied in order to adjust weights, giving more trust to points closer to the true distance. Weighted points from overlapping images may be averaged, moving the MLS surface closer to ground truth values, and thus, increasing point cloud accuracy.

At step 610, a mesh representation associated with the environment may be generated based on the refined point cloud. For example, the computing device (e.g., computing device 101) may generate the mesh representation associated with the environment based on the refined point cloud. The mesh representation associated with the environment may comprise a digital twin of the environment. For example, the filtered and refined point cloud may be converted into a mesh representation of the environment, capturing essential structural details of the environment. In an example, the mesh representation may be further decimated based on reducing a point density of the mesh representation in order to ensure a balance between an accuracy and a storage efficiency of the mesh representation.

In an example, one or more user interactions with the mesh representation may be received via a user interface of the computing device. Measurement data associated with the environment may be determined based on the one or more user interactions with the mesh representation. The measurement data may comprise one or more of feature locations associated with the environment, distance measurements associated with the environment, or geospatial coordinates associated with the environment. As an example, the measurement data may be generated based on mapping 2D image pixels of the imaging data to 3D points of the mesh representation (e.g., raycasting) and mapping 3D points of the mesh representation back onto 2D images of the imaging data (e.g., projection). For example, raycasting may enable users to select a 2D image pixel and trace the pixel to a corresponding 3D location within the mesh representation in order to facilitate spatial queries (e.g., enabling interactions with the mesh representation). For example, the projection process may project 3D points of the mesh representation onto 2D images of the image data to generate a direct correspondence that allows for image-based metric analysis (e.g., determine measurement data associated with the environment and/or the one or more physical objects based on interacting with the mesh representation).

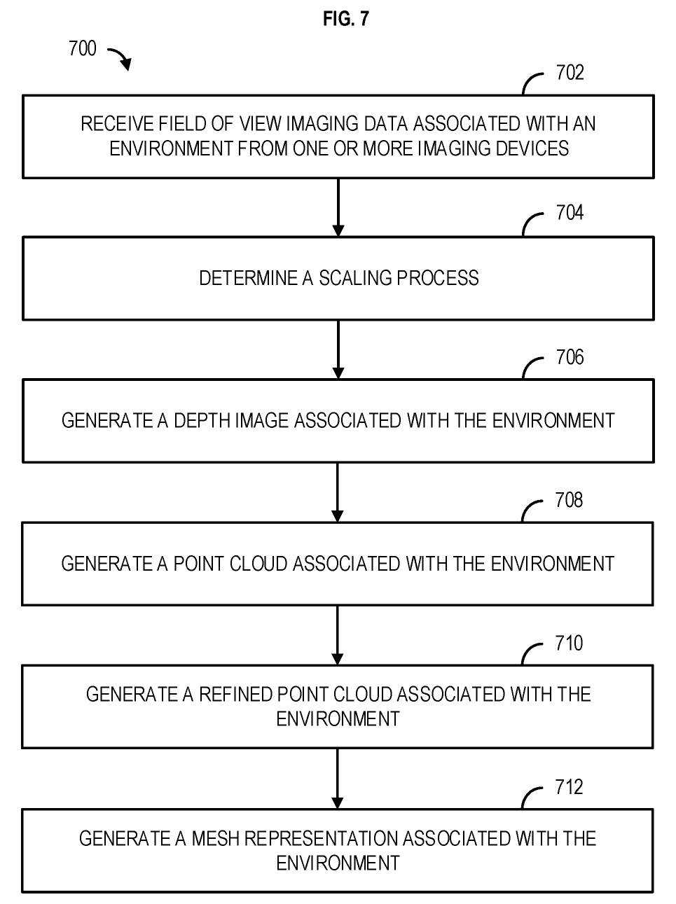

FIG. 7 shows a flowchart of an example method 700. The method 700 may be implemented by a computing device such as computing device 101, imaging devices 102, combinations thereof, and the like. At step 702, field of view imaging data associated with an environment from one or more imaging devices may be received. For example, a computing device (e.g., computing device 101) may receive the field of view imaging data associated with an environment from the one or more imaging devices (e.g., imaging devices 102). The one or more imaging devices may comprise one or more RGB camera devices. Each imaging device of the one or more imaging devices may comprise one or more imaging devices comprises one or more of a gimbal, a GPS sensor, an accelerometer, or an inertial measurement unit. The field of view imaging data may comprise one or more pixel-based images of the environment, GPS data associated with the one or more imaging devices, real-time kinematics (RTK) data associated with the one or more imaging devices, distance data associated with the one or more imaging devices, orientation data associated with the one or more imaging devices, pose metadata, or one or more combinations thereof. The environment may comprise one or more physical objects.

At step 704, a scaling process may be determined based on a first two images of the imaging data. For example, the computing device (e.g., computing device 101) may determine the scaling process based on the first two images of the imaging data. The determined scaling process may comprise triangulating features associated with the first two images according to pose data associated with the one or more imaging devices or optimizing for scale correction to match an expected scene depth according to the pose data. As an example, if the first two images have sufficient features (e.g., around a base of a wind turbine blade), the features of the first two images may be triangulated using the pose data and one or more intrinsic imaging device parameters. The pose data and the one or more intrinsic imaging device parameters (e.g., focal length, principal point, skew coefficient, pixels per unit, distortion coefficients, scale, etc.) may be used to scale an initial depth-based point cloud. As an example, if the first two images lack sufficient features, photometric consistency may be assumed between images of the imaging data. For example, scale correction may be optimized with known poses (e.g., rotation determined from gimbal data and translation calculated from RTK GPS) in order to match an expected scene depth.

At step 706, a depth image associated with the environment may be generated based on an image of the imaging data. For example, the computing device (e.g., computing device 101) may generate the depth image associated with the environment based on the image of the imaging data. As an example, the depth image may be generated based on applying a depth estimation model (e.g., Depth Anything) to the image of the imaging data.

As an example, GPS positioning data may be refined based on combining (e.g., via sensor fusion) IMU data and the RTK data of the one or more image imaging devices. A coordinate origin may be set based on defining a first GPS location of the one or more imaging devices as an origin and then calculating a Cartesian position of each of the imaging devices based on the refined GPS positioning data. An orientation of each of the imaging devices may be determined based on applying a complementary filter to combine GPS heading data and RTK yaw data (e.g., a combination of a low-pass and high-pass filter to estimate an orientation/yaw of each of the imaging devices by combining accelerometer data and gyroscope data). In an example, roll and pitch of each of the imaging devices may be determined in order to generate a rotation matrix (e.g., using the Euler angles). A pose for each image of each of the imaging devices may be determined based on the Cartesian positions of each of the imaging devices and the rotation matrix of each of the imaging devices.

At step 708, a point cloud associated with the environment may be generated based on the determined scaling process and the depth image. For example, the computing device (e.g., computing device 101) may generate the point cloud associated with the environment based on the determined scaling process and the depth image. For example, the point cloud may be generated based on iteratively adding data to an initial point cloud associated with the environment. For example, the initial point cloud associated with the environment may be generated based on the depth image. For each subsequent image from the image, a corresponding previously scaled point cloud may be iteratively projected onto the corresponding subsequent image based on pose data associated with the one or more imaging devices. A subsequent depth image may be iteratively generated based on the corresponding projection. Data may be iteratively added to the initial point cloud based on each corresponding subsequent depth image. Each iteration of the initial point cloud may be scaled according to the determined scaling process.

At step 710, a refined point cloud associated with the environment may be generated based on applying a data refinement process to the point cloud. For example, the computing device (e.g., computing device 101) may generate the refined point cloud associated with the environment based on applying the data refinement process to the point cloud. The refinement process may comprise a weighted moving least square process or a screened Poisson reconstruction process. As an example, a WMLS may be used to improve point cloud accuracy by correcting depth estimates. A radius-based neighborhood around each point in the cloud may be defined. Ground truth data from the LRF may be used to implement absolute scaling. A Gaussian fall-off may be applied in order to adjust weights, giving more trust to points closer to the true distance. Weighted points from overlapping images may be averaged, moving the MLS surface closer to ground truth values, and thus, increasing point cloud accuracy.

At step 712, a mesh representation associated with the environment may be generated based on the refined point cloud. For example, the computing device (e.g., computing device 101) may generate the mesh representation associated with the environment based on the refined point cloud. The mesh representation associated with the environment may comprise a digital twin of the environment. For example, the filtered and refined point cloud may be converted into a mesh representation of the environment, capturing essential structural details of the environment. In an example, the mesh representation may be further decimated based on reducing a point density of the mesh representation in order to ensure a balance between an accuracy and a storage efficiency of the mesh representation. For example, a user may provide input setting a 1% fault/error threshold according to an object’s bounding box (e.g., X meters diagonally) or by absolute number in metric unit ( e.g., X mm). A mesh representation subsequently generated from the point cloud may be iteratively decimated until the Hausdorff distance between an original and a decimated mesh representation is within the fault threshold. For example, a non-shrinking smoothing function such as a taubin smoothing process may be applied to the mesh representation for a heavier smoothing. In an example, the mesh representation may be trimmed based on a distance from the point cloud, wherein the mesh representation may be decimated based on applying a Quadric Error Metric Decimation to the mesh representation.

In an example, one or more user interactions with the mesh representation may be received via a user interface of the computing device. Measurement data associated with the environment may be determined based on the one or more user interactions with the mesh representation. The measurement data may comprise one or more of feature locations associated with the environment, distance measurements associated with the environment, or geospatial coordinates associated with the environment. As an example, the measurement data may be generated based on mapping 2D image pixels of the imaging data to 3D points of the mesh representation (e.g., raycasting) and mapping 3D points of the mesh representation back onto 2D images of the imaging data (e.g., projection). For example, raycasting may enable users to select a 2D image pixel and trace the pixel to a corresponding 3D location within the mesh representation in order to facilitate spatial queries (e.g., enabling interactions with the mesh representation). For example, the projection process may project 3D points of the mesh representation onto 2D images of the image data to generate a direct correspondence that allows for image-based metric analysis (e.g., determine measurement data associated with the environment and/or the one or more physical objects based on interacting with the mesh representation).

For purposes of illustration, application programs and other executable program components are illustrated herein as discrete blocks, although it is recognized that such programs and components can reside at various times in different storage components. An implementation of the described methods can be stored on or transmitted across some form of computer readable media. Any of the disclosed methods can be performed by computer readable instructions embodied on computer readable media. Computer readable media can be any available media that can be accessed by a computer. By way of example and not meant to be limiting, computer readable media can comprise “computer storage media” and “communications media.” “Computer storage media” can comprise volatile and non-volatile, removable and non-removable media implemented in any methods or technology for storage of information such as computer readable instructions, data structures, program modules, or other data. Exemplary computer storage media can comprise RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

While the methods and systems have been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

It will be apparent to those skilled in the art that various modifications and variations can be made without departing from the scope or spirit. Other embodiments will be apparent to those skilled in the art from consideration of the specification and practice disclosed herein. It is intended that the specification and examples be considered as exemplary only, with a true scope and spirit being indicated by the following claims.

1. One or more non-transitory computer-readable media storing processor-executable instructions that, when executed by at least one processor, cause the at least one processor to:
receive, by a computing device, from one or more imaging devices, image data of an environment and laser range finder (LRF) time series data associated with the image data;
determine, based on an application of a time series forecasting model to the LRF time series data, one or more missing LRF values from the LRF time series data;
modify the LRF time series data to include the one or more missing LRF values;
generate, based on the image data and the modified LRF time series data, a point cloud associated with the environment; and
generate, based on the point cloud associated with the environment, a mesh representation associated with the environment.

2. The non-transitory computer-readable media of claim 1, wherein the one or more imaging devices comprise one or more RGB camera devices, wherein each imaging device of the one or more imaging devices comprises one or more of a gimbal, a GPS sensor, a laser range finder, an accelerometer, or an inertial measurement unit.

3. The non-transitory computer-readable media of claim 1, wherein the environment comprises one or more physical objects.

4. The non-transitory computer-readable media of claim 1, wherein the time series forecasting model comprises a Seasonal AutoRegressive Integrated Moving Average with eXogenous factors (SARIMAX) model.

5. The non-transitory computer-readable media of claim 1, wherein the processor-executable instructions that, when executed by the at least one processor, cause the at least one processor to determine, based on the application of the time series forecasting model to the LRF time series data, the one or more missing LRF values from the LRF time series data, further cause the at least one processor to:
predict, based on the application of the time series forecasting model to the LRF time series data, one or more missing values from the LRF time series data; and
generate, based on applying a smoothing process to the one or more missing values, the one or more missing LRF values from the LRF time series data.

6. The non-transitory computer-readable media of claim 1, wherein the processor-executable instructions, when executed by the at least one processor, further cause the at least one processor to:
train, based on one or more parameter combinations, the time series forecasting model, wherein the parameters of the one or more parameter combinations comprise one or more initial parameters associated with non-seasonal cases and one or more initial parameters associated with seasonal cases;
optimize the time series forecasting model; and
output, based on training the time series forecasting model and based on optimizing the time series forecasting model, the time series forecasting model, wherein the time series forecasting model, once trained and optimized, is configured to predict missing time series values.

7. The non-transitory computer-readable media of claim 1, wherein the processor-executable instructions that, when executed by the at least one processor, cause the at least one processor to generate, based on the point cloud associated with the environment, the mesh representation associated with the environment, further cause the at least one processor to:
generate, based on reducing one or more data points of the point cloud, a decimated point cloud associated with the environment;
generate, based on applying a data refinement process to the decimated point cloud, a refined point cloud associated with the environment; and
generate, based on the refined point cloud, the mesh representation associated with the environment.

8. The non-transitory computer-readable media of claim 7, wherein the processor-executable instructions that, when executed by the at least one processor, cause the at least one processor to reduce the one or more data points of the point cloud, further cause the at least one processor to reduce, based on applying voxel filtering to the point cloud, a point density associated with the point cloud.

9. The non-transitory computer-readable media of claim 7, wherein the data refinement process comprises one or more of a weighted moving least square process or a screened Poisson reconstruction process.

10. The non-transitory computer-readable media of claim 1, wherein the processor-executable instructions, when executed by the at least one processor, further cause the at least one processor to:
receive, via a user interface of the computing device, one or more user interactions with the mesh representation; and
determine, based on the one or more user interactions with the mesh representation, measurement data associated with the environment,
wherein the measurement data comprises one or more of feature locations associated with the environment, distance measurements associated with the environment, or geospatial coordinates associated with the environment.

11. A system comprising:
one or more imaging devices configured to send image data of an environment and laser range finder (LRF) time series data associated with the image data; and
a computing device configured to:
receive, from the one or more imaging devices, the image data of the environment and the LRF time series data associated with the image data,
determine, based on an application of a time series forecasting model to the LRF time series data, one or more missing LRF values from the LRF time series data,
modify the LRF time series data to include the one or more missing LRF values;
generate, based on the image data and the modified LRF time series data, a point cloud associated with the environment, and
generate, based on the point cloud associated with the environment, a mesh representation associated with the environment.

12. The system of claim 11, wherein the one or more imaging devices comprise one or more RGB camera devices, wherein each imaging device of the one or more imaging devices comprises one or more of a gimbal, a GPS sensor, a laser range finder, an accelerometer, or an inertial measurement unit.

13. The system of claim 11, wherein the environment comprises one or more physical objects.

14. The system of claim 11, wherein the time series forecasting model comprises a Seasonal AutoRegressive Integrated Moving Average with eXogenous factors (SARIMAX) model.

15. The system of claim 11, wherein the computing device is configured to determine, based on the application of the time series forecasting model to the LRF time series data, the one or more missing LRF values from the LRF time series data, the computing device is further configured to:
predict, based on the application of the time series forecasting model to the LRF time series data, one or more missing values from the LRF time series data; and
generate, based on applying a smoothing process to the one or more missing values, the one or more missing LRF values from the LRF time series data.

16. The system of claim 11, wherein the computing device is further configured to:
train, based on one or more parameter combinations, the time series forecasting model, wherein the parameters of the one or more parameter combinations comprise one or more initial parameters associated with non-seasonal cases and one or more initial parameters associated with seasonal cases;
optimize the time series forecasting model; and
output, based on training the time series forecasting model and based on optimizing the time series forecasting model, the time series forecasting model, wherein the time series forecasting model, once trained and optimized, is configured to predict missing time series values.

17. The system of claim 11, wherein the computing device is configured to generate, based on the point cloud associated with the environment, the mesh representation associated with the environment, the computing device is further configured to:
generate, based on reducing one or more data points of the point cloud, a decimated point cloud associated with the environment;
generate, based on applying a data refinement process to the decimated point cloud, a refined point cloud associated with the environment; and
generate, based on the refined point cloud, the mesh representation associated with the environment.

18. The system of claim 17, wherein the computing device is configured to reduce the one or more data points of the point cloud, the computing device is further configured to reduce, based on applying voxel filtering to the point cloud, a point density associated with the point cloud.

19. The system of claim 17, wherein the data refinement process comprises one or more of a weighted moving least square process or a screened Poisson reconstruction process.

20. The system of claim 11, wherein the computing device is further configured to:
receive, via a user interface of the computing device, one or more user interactions with the mesh representation; and
determine, based on the one or more user interactions with the mesh representation, measurement data associated with the environment,
wherein the measurement data comprises one or more of feature locations associated with the environment, distance measurements associated with the environment, or geospatial coordinates associated with the environment.

21. A method comprising:
receiving, by a computing device, from one or more imaging devices, image data of an environment and laser range finder (LRF) time series data associated with the image data;
determining, based on an application of a time series forecasting model to the LRF time series data, one or more missing LRF values from the LRF time series data;
modifying the LRF time series data to include the one or more missing LRF values;
generating, based on the image data and the modified LRF time series data, a point cloud associated with the environment; and
generating, based on the point cloud associated with the environment, a mesh representation associated with the environment.

22. The method of claim 21, wherein determining, based on the application of the time series forecasting model to the LRF time series data, the one or more missing LRF values from the LRF time series data comprises:
predicting, based on the application of the time series forecasting model to the LRF time series data, one or more missing values from the LRF time series data; and
generating, based on applying a smoothing process to the one or more missing values, the one or more missing LRF values from the LRF time series data.

23. The method of claim 21, further comprising:
training, based on one or more parameter combinations, the time series forecasting model, wherein the parameters of the one or more parameter combinations comprise one or more initial parameters associated with non-seasonal cases and one or more initial parameters associated with seasonal cases;
optimizing the time series forecasting model; and
outputting, based on training the time series forecasting model and based on optimizing the time series forecasting model, the time series forecasting model, wherein the time series forecasting model, once trained and optimized, is configured to predict missing time series values.

24. The method of claim 21, further comprising:
receiving, via a user interface of the computing device, one or more user interactions with the mesh representation; and
determining, based on the one or more user interactions with the mesh representation, measurement data associated with the environment,
wherein the measurement data comprises one or more of feature locations associated with the environment, distance measurements associated with the environment, or geospatial coordinates associated with the environment.
